(19) United States
(12) Patent Application Publication
(10) Pub. No.: US 2007/0061213 A1
(43) Pub. Date: Mar. 15, 2007

(54) Method for perpetually providing goods or service

(76) Inventor: Herman Frank Krantz, Sun City, CA (US)

Correspondence Address: PAUL J. COOK, 115 PINE STREET, MANCHESTER, MA, 01944, US

(21) Appl. No.: 11/222,455

(22) Filed: Sep. 9, 2005

(51) Int. Cl. G06Q 30/00

(52) U.S. Cl. 705/26

(57) ABSTRACT

A method for perpetually providing goods and/or services to a customer of an original supplier or successor to an original supplier is provided. An entity separate from the original supplier or successor to the original supplier is provided with a goods and /or service list wherein each good and/or service is identified with a unique indicia. The customer is notified that at any time, regardless of change of status of the original supplier or successor to the original supplier, the customer always can obtain desired goods and/or services by contacting the separate entity. The separate entity notifies the original supplier of the needed part and/or service. The original supplier and/or successor to the original supplier then supplies the part and/or service to the customer.

### BACKGROUND OF THE INVENTION

This invention relates to a method for providing goods such as parts or services to customers. More particularly, this invention relates to a method for providing goods and/or services perpetually to customers when the original providers of goods and/or service changes its status as its original entity.

Business entities that provide goods and services are required to provide a means for making available replacement parts and/or services over the normal useful life of the originally provided parts or services. Otherwise, the original customer would not be adequately protected under the normal warranties such as provided by the Uniform Commercial Code.

Problems arise in perpetually providing such goods and services when the original provider ceases to exist in its original form. For example, the original provider can merge with or sell to or lease to a separate business entity, sell part of its business, buy a separate product line or go out of business. When these events occur, the original customer experiences difficulty in locating the original provider to obtain replacement parts or services needed to continue satisfactory utilization of the originally purchased goods.

Possible solutions include maintaining a post office box number and change destination as required. This is undesirable since it subjects the business entity to unnecessary government regulation. The original provider also can maintain an independent agency to monitor the need for parts or services. However, this would require paying the agency and undesirably increasing costs. Another alternative would be to notify all customers whenever such changes to the original provider occur. This approach also is undesirably costly.

Accordingly, it would be desirable to provide a method for permitting reliable continuance of providing parts and/or services to customers of an original provider even when changes in status of the original provider are made. It would also be desirable that such a method process customers' inquiries promptly and at reasonable cost.

### SUMMARY OF THE INVENTION

This invention provides a method for providing a perpetual link between customers and original providers or successors to the original provider of goods such as parts and/or services to the customers. At the time of original transfer, such as sale or lease of goods to a customer by an original provider or successor to the original provider, the customer is notified to contact an established separate entity or the separate entity as well as the original provider or successor to the original provider for required further goods and/or services. The separate entity must have expertise in communication with the industry from which the original goods or services are provided. The separate entity should provide a goods and/or service list wherein each part is identified with an unique indicia such as by number, by letter, name, code name or a combination thereof plus a second such indicia that identifies the supplier of the original goods and/or services to the customer. The customer, when in need of additional goods and/or services then contacts the separate entity or the supplier of the original goods and or services. When the original supplier of the goods and/or services ceases to exist or changes its status which renders communication from the customer difficult, the customer always can contact the separate entity to obtain desired goods and/or services. The separate entity then can notify the original supplier or successor to the original supplier for the need of additional goods and/or services to a particular customer. The separate entity is notified by the original supplier or successor to the original supplier of the goods and/or services any change in its status. Change of status means any change that alters the ability of the customer to communicate with a supplier of desired goods and/or services such as merger with another company, sale of all or a portion of its business, lease to another company, move to another location, purchase a separate product line, cease doing business or the like.

By operating in this manner, any inquiry by the customer to the separate entity for goods and/or services can be directed to the original supplier or successor to the original supplier by the separate entity. Thus, a perpetual link is maintained between the customer and original supplier or successor to the original supplier or separate entity so that the customer always can obtain the desired goods and/or services.

### DESCRIPTION OF SPECIFIC EMBODIMENTS

In accordance with this invention, a method for perpetually providing goods and/or services to a customer by an original supplier or successor to the original supplier or a separate entity to the customer is provided. The invention is based upon the use of a separate entity separate from the original supplier or successor to the original supplier that provides communication between the customer and the separate entity or original supplier or successor to the original supplier regarding continuing need for goods and/or services by the customer. The separate entity should have expertise in communication in the industry within which the goods and/or services are supplied.

The separate entity is provided with a goods list which identifies each good or service with indicia of the separate entity and a unique indicia associated with each good or service such as with numbers, letters or a combination thereof. Representative goods and/or services include parts, products, groups of parts, groups of products, or services available to a customer. For example, the parts could be listed as:
255-A-Compressors, ammonia
255-B-Compressors other than ammonia
255-C-Air Units, refrigeration, floor and ceiling.
255-D-Oil Separators
   Together with the original goods, the nameplates, literature, bulletins, instruction manuals or the like added information is provided such as:
“Parts & Services, XXX No. 255-A” or “XXX No. 255-A for Services” wherein XXX identifies the name, location and contact information for the separate entity.

The customer, in need of additional parts and/or services can obtain needed parts and/or services in accordance with this invention as follows:
1. Contact the separate entity, XXX from the original information provided the customer, requesting that certain data or information be forwarded to the original supplier or successor to the original supplier represented by the unique indicia such as “255-A” or “255-D”.
2. The separate entity transmits the information from step 1 to the original provider or successor to the original provider.
3. The original provider or successor to the original provider then provides the needed parts and/or services to the customer.

By operating with the method of the invention set forth above, no cost would be incurred in notifying the customers of the business of location change or change in status of the original provider, thus providing savings to change letterheads, stamps, literature, telephone listings, fax, listings, e-mail addresses and the like.

1. The method for providing goods and/or services to a customer of an original supplier of goods and/or services which comprises:
a. providing a separate entity having expertise for communicating with an industry which provides said goods and/or services which identifies the original supplier or successor in business of the original supplier and identifies each goods or service with a unique indicia,
b. informing said customer that said customer can communicate with said separate entity when said customer requires a goods and/or a service from said original supplier or said successor to said original supplier.
c. means for said separate entity to communicate with said original supplier or successor to said original supplier and
d. means for said original supplier or successor or said separate entity to provide said goods and/or service to said customer.

2. The method of claim 1 wherein said goods are identified by number.

3. The method of claim 1 wherein said goods are identified by like letters.

4. The method of claim 1 wherein said goods are identified by numbers and letters.

5. The method of claim 1 wherein said goods are identified by code names.

6. The method of claim 1 wherein said goods are identified by names.
